(19) United States
(12) Patent Application Publication
(10) Pub. No.: US 2014/0327874 A1
(43) Pub. Date: Nov. 6, 2014

(54) EYEGLASSES TEMPLE AND MOLDING UNIT FOR MAKING THE SAME

(71) Applicant: PROHERO GROUP CO., LTD., TAINAN CITY (TW)

(72) Inventor: PEN-WEI CHEN, TAINAN CITY (TW)

(73) Assignee: PROHERO GROUP CO., LTD., TAINAN CITY (TW)

(21) Appl. No.: 13/886,516

(22) Filed: May 3, 2013

(51) Int. Cl. G02C 5/14; B29C 45/14

(52) U.S. Cl. CPC G02C 5/14; B29C 45/14426; B29C 45/14065
USPC 351/121; 425/500

(57) ABSTRACT

A temple includes a connection portion, a first member, a body portion and a second member. The two respective diameters of the first 12 and the second member are larger than the diameter of the body portion. Multiple through holes are defined through the body portion. A metal rod is located in the temple. The material of a soft coating is injected to the body portion and extends through the through holes so as to form protrusions to reinforce the connection between the body portion and the soft coating.

### BACKGROUND OF THE INVENTION

1. Fields of the Invention

The present invention relates to a temple for a pair of eyeglasses and a molding unit for making the temple, and more particularly, to a temple with a recessed area between a first member and a second member on two ends of the temple.

2. Descriptions of Related Art

The conventional temple and molding unit for making the same is disclosed in Taiwan Publish NO. M350718, and the temple has a soft coating mounted to a metal rod thereof so as to save the electro-coating processes to reduce the manufacturing cost. The soft coating also prevents the metal rod from being oxidization. However, the soft coating is made by rubber and has less durability so that the soft coating is worn out easily. Once the soft coating is worn out, the metal rod is easily oxidized and rusted. The oxidized and rusted metal rod may be harmful to the user's skin.

The present invention intends to provide a temple which has a recessed area between the first and second members on two ends of the metal rod so that the soft coating is engaged with the recessed area of the metal rod.

### SUMMARY OF THE INVENTION

The present invention relates to a temple and comprises a connection portion, a first member, a body portion and a second member. The two respective diameters of the first 12 and the second member are larger than the diameter of the body portion. Multiple through holes are defined through the body portion. A metal rod is located in the temple.

Alternatively, the present invention provides a molding unit for making a temple and comprises a first mold and a second mold. The first mold has a first cavity which comprises a first formation portion, a second formation portion, a third formation portion and a fourth formation portion. The second mold has a second cavity which comprises a fifth formation portion, a sixth formation portion, a seventh formation portion and an eighth formation portion. The fifth, sixth, seventh and eighth formation portions are located corresponding to the first, second, third and fourth formation portions. The first and second cavities define a space for forming a temple. Two respective depths of the first and sixth formation portions and two respective depths of the fourth and eighth formation portions are deeper than two respective depths of the third and seventh formation portions. Each of the third and seventh formation portions has positioning rods which clamp and position a metal rod in the first and second cavities.

The plastic temple encloses the metal rod therein, the plastic material is durable so as to ensure that the metal rod in the temple is not oxidized and worn.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the temple of the present invention;

FIG. 2 is a cross sectional view of the molding unit making the temple of the present invention;

FIG. 3 is a cross sectional view of the second embodiment of the molding unit making the temple of the present invention;

FIG. 4 is a cross sectional view of the third embodiment of the molding unit making the temple of the present invention, and

FIG. 5 is a cross sectional view of the fourth embodiment of the molding unit making the temple of the present invention.

### DETAILED DESCRIPTION OF THE PREFERRED EMBODIMENTS

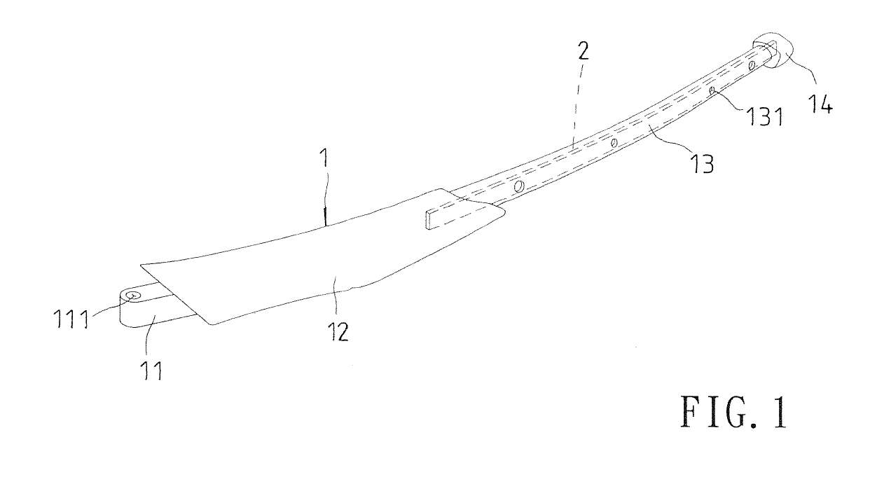

Referring to FIG. 1, a temple 1 of the present invention is made by plastic and comprises a connection portion 11, a first member 12, a body portion 13 and a second member 14 in sequence. A pivotal hole 111 is defined through the connection portion 11 so as to be pivotably connected with the rim of a pair of eyeglasses (not shown). The two respective diameters of the first member 12 and the second member 14 are larger than the diameter of the body portion 13. Multiple through holes 131 are defined through the body portion 13. A metal rod 2 is located in the temple 1.

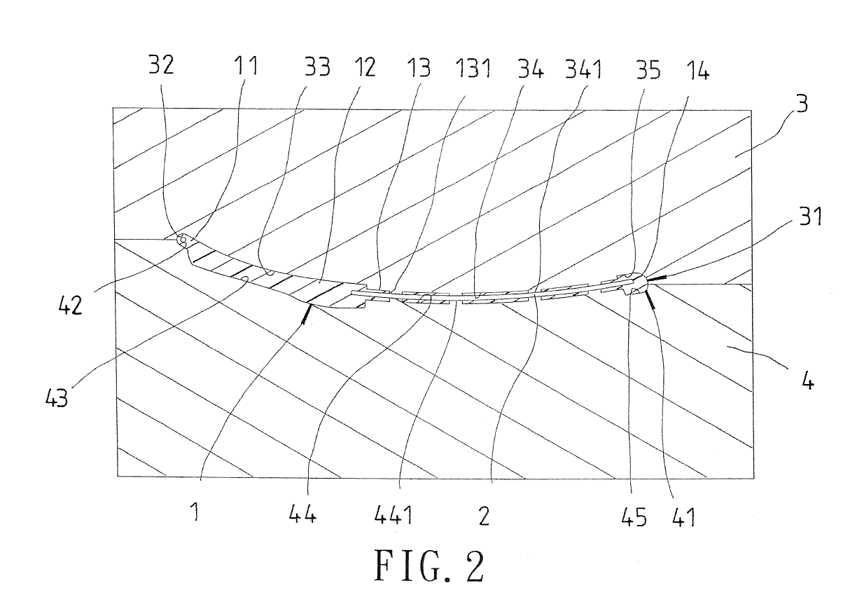

Referring to FIGS. 1 and 2, the molding unit for making the temple 1 of the present invention comprises a first mold 3 and a second mold 4. The first mold 3 has a first cavity 31 and the second mold 4 has a second cavity 41. A space is defined between the first and second cavities 31, 41 so as to make the temple 1 therein. The first cavity 31 comprises a first formation portion 32, a second formation portion 33, a third formation portion 34 and a fourth formation portion 35. The second cavity 41 comprises a fifth formation portion 42, a sixth formation portion 43, a seventh formation portion 44 and an eighth formation portion 45. The fifth, sixth, seventh and eighth formation portions 42, 43, 44, 45 are located corresponding to the first, second, third and fourth formation portions 32, 33, 34, 35. The two respective depths of the first and sixth formation portions 33, 43 and the two respective depths of the fourth and eighth formation portions 35, 45 are deeper than the two respective depths of the third and seventh formation portions 34, 44. Each of the third and seventh formation portions 34, 44 has positioning rods 341/441 which clamp and position the left and right sides of the metal rod 2 in the first and second cavities 31, 41, so that the metal rod 2 is well positioned in the space defined by the first and second cavities 31, 41. The melted plastic material is injected into the space defined by the first and second cavities 31, 41. After the plastic material is cooled, the temple 1 is formed with plastic material at outside and the metal rod 2 at inside of the temple 1. The first and fifth formation portions 32, 42 are located corresponding to the connection portion 11. The second and sixth formation portions 33, 43 are located corresponding to the first member 12. The third and seventh formation portions 34, 44 are located corresponding to the body portion 13. The positioning rods 341, 441 of the third and seventh formation portions 34, 44 are inserted into the through holes 131 of the left and right sides of the metal rod 2. The fourth and eighth formation portions 35, 45 are located corresponding to the second member 14.

By the plastic temple 1 encloses the metal rod 2, the temple 1 is flexible and the plastic is durable to prevent the metal rod 2 from corrosion. Besides, the body portion 13 is coated by rubber coating or hard plastic which has different color relative to the rest portions of the temple 1. The rubber coating or the hard plastic have protrusions formed at the positions where the through holes 131 of the body portion 13 are located so that the protrusions are inserted into the through holes 131 to reinforce the connection between the body portion 13 and the rubber coating or the hard plastic. The metal rod 2 is completely enclosed by the rubber coating or the hard plastic so as to improve the shortcomings of the conventional temple whose metal rod is coated only by the soft rubber coating which is easily worn out.

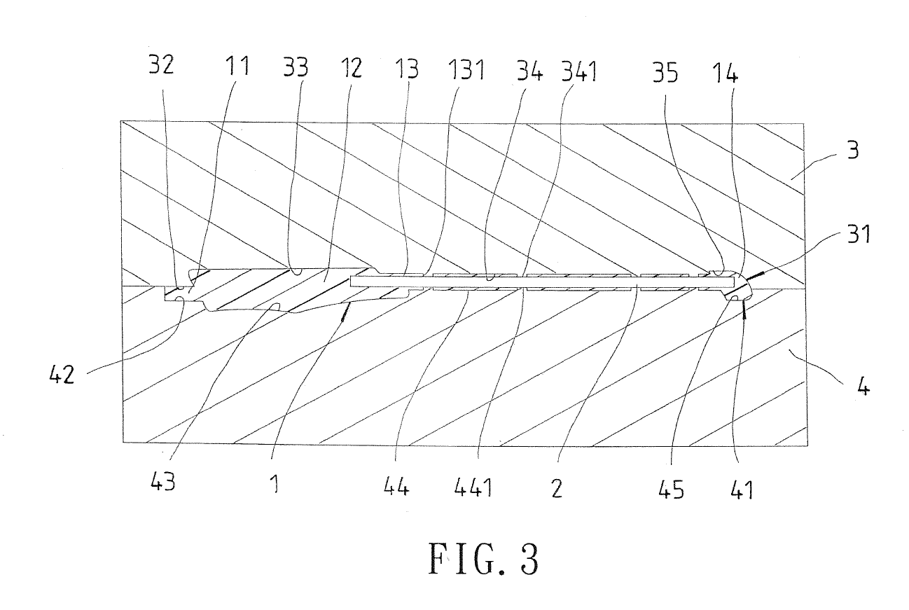

Referring to FIG. 3, the first and second molds 3, 4 are located at the top and the bottom of the metal rod 2 so that the positioning rods 341, 441 of the third and seventh formation portions 34, 44 are located correspondingly or alternatively to each other to clamp the top and bottom of the metal rod 2.

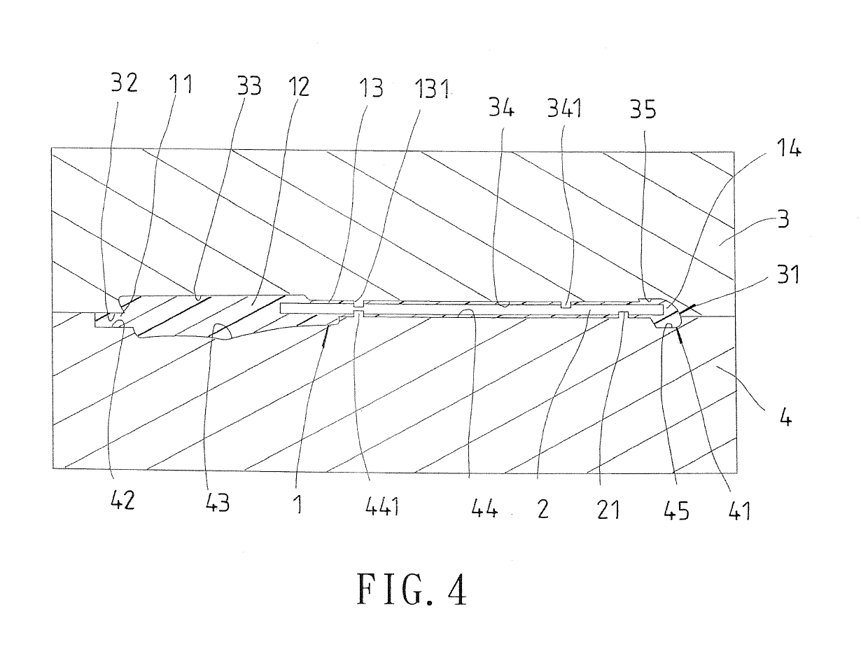

Referring to FIG. 4, the first and second molds 3, 4 are located at the top and the bottom of the metal rod 2. The metal rod 2 has recesses 21 defined in the top and the bottom thereof. The positioning rods 341, 441 of the third and seventh formation portions 34, 44 are inserted into the recesses 21 in the top and bottom of the metal rod 2. Alternatively, the first and second molds 3, 4 are located at right and left sides of the metal rod 2. The metal rod 2 has recesses 21 defined in the left and right sides thereof. The positioning rods 341, 441 of the third and seventh formation portions 34, 44 are inserted into the recesses 21 in the left and right sides of the metal rod 2.

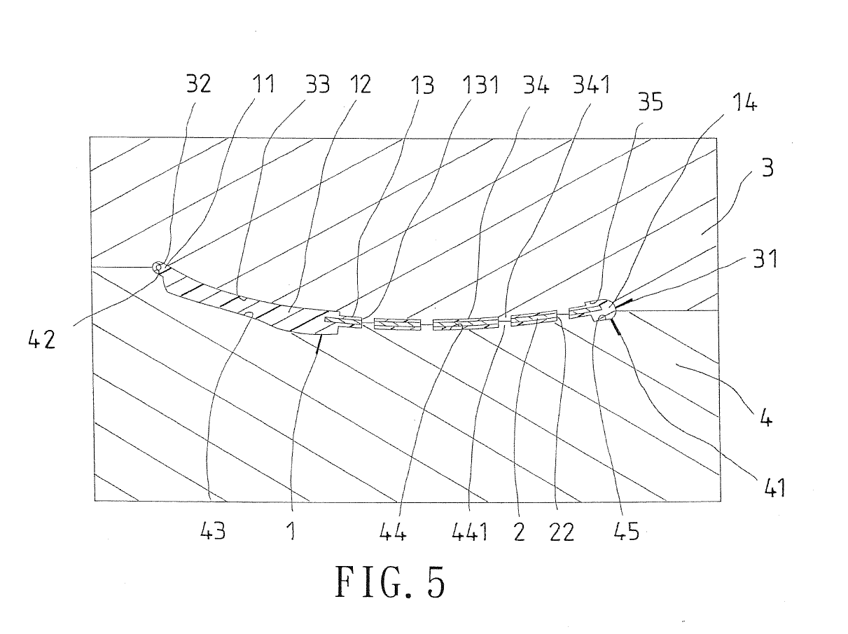

Referring to FIG. 5, the first and second molds 3, 4 are located at left and right sides of the metal rod 1 The metal rod 2 has passages 22 defined through the left and right sides thereof. The positioning rods 341, 441 of the third and seventh formation portions 34, 44 are inserted into the passages 22 in the left and right sides of the metal rod 2.

While we have shown and described the embodiment in accordance with the present invention, it should be clear to those skilled in the art that further embodiments may be made without departing from the scope of the present invention.

What is claimed is:

1. A temple comprising:
a connection portion, a first member, a body portion and a second member, two respective diameters of the first member and the second member being larger than a diameter of the body portion, multiple through holes defined through the body portion, and
a metal rod being located in the temple.

2. The temple as claimed in claim 1, wherein the metal rod has multiple recesses defined in two sides thereof and the recesses are located corresponding to the through holes of the body portion of the temple.

3. The temple as claimed in claim 1, wherein the metal rod has multiple recesses defined in a top and a bottom thereof, the recesses are located corresponding to the through holes of the body portion of the temple.

4. The temple as claimed in claim 1, wherein the metal rod has multiple passages defined through two respective sides thereof, the passages are located corresponding to the through holes of the body portion of the temple.

5. A molding unit for making a temple, comprising:
a first mold having a first cavity, the first cavity having a first formation portion, a second formation portion, a third formation portion and a fourth formation portion;
a second mold having a second cavity, the second cavity having a fifth formation portion, a sixth formation portion, a seventh formation portion and an eighth formation portion, the fifth, sixth, seventh and eighth formation portions being located corresponding to the first, second, third and fourth formation portions, a space defined between the first and second cavities for making a temple, two respective depths of the first and sixth formation portions and two respective depths of the fourth and eighth formation portions being deeper than two respective depths of the third and seventh formation portions, each of the third and seventh formation portions having positioning rods which clamp and position a metal rod in the first and second cavities.

6. The molding unit as claimed in claim 5, wherein the first and second molds are located at left and right sides of the metal rod so that the positioning rods of the third and seventh formation portions clamp left and right sides of the metal rod.

7. The molding unit as claimed in claim 5, wherein the first and second molds are located at top and bottom of the metal rod so that the positioning rods of the third and seventh formation portions clamp the top and the bottom of the metal rod.

8. The molding unit as claimed in claim 5, wherein the first and second molds are located at right and left of the metal rod, the metal rod has recesses defined in the left and right sides thereof, the positioning rods of the third and seventh formation portions are inserted into the recesses in the left and right sides of the metal rod.

9. The molding unit as claimed in claim 5, wherein the first and second molds are located at top and bottom of the metal rod, the metal rod has recesses defined in the top and the bottom thereof, the positioning rods of the third and seventh formation portions are inserted into the recesses in the top and the bottom of the metal rod.

10. The molding unit as claimed in claim 5, wherein the first and second molds are located at left and right sides of the metal rod, the metal rod has passages defined through the left and right sides thereof, the positioning rods of the third and seventh formation portions are inserted into the passages in the left and right sides of the metal rod.
